(19) United States
(12) Patent Application Publication
(10) Pub. No.: US 2018/0308416 A1
(43) Pub. Date: Oct. 25, 2018

(54) DISPLAY APPARATUS AND CONTROL CIRCUIT AND CONTROL METHOD THEREOF

(71) Applicants: HKC Corporation Limited, Shenzhen (CN); Chongqing HKC Optoelectronics Technology Co., ltd., Chongqing (CN)

(72) Inventor: Wei Chen, Chongqing (CN)

(21) Appl. No.: 15/847,501

(22) Filed: Dec. 19, 2017

Related U.S. Application Data
(63) Continuation of application No. PCT/CN2017/088736, filed on Jun. 16, 2017.

(30) Foreign Application Priority Data
Apr. 24, 2017 (CN) 201710271785.X

(51) Int. Cl. G09G 3/20; G06F 13/40; G06F 13/42; G06T 1/60

(52) U.S. Cl. CPC G09G 3/2096; G06F 13/4072; G06F 13/4282; G09G 3/2007; G09G 2320/0233; G09G 2370/08; G09G 2370/04; G09G 2310/08; G09G 2360/10; G06T 1/60

(57) ABSTRACT

A display apparatus and a control circuit as well as a control method thereof are provided. The control circuit of the display apparatus includes: a communication circuitry; a display driver chip; a master chip electrically connected to the display driver chip through the communication circuitry; and a memory chip electrically connected to the master chip through the communication circuitry. The memory chip is used for storing a first configuration parameter of the master chip and a second configuration parameter of the display driver chip of an electronic equipment. The master chip is used for reading the first configuration parameter and the second configuration parameter from the memory chip and sending the second configuration parameter to the display driver chip.

### FIELD OF THE DISCLOSURE

The disclosure relates to the field of circuitry, and more particularly to a display apparatus and a control circuit as well as a control method thereof.

### BACKGROUND

At present, a television system is mainly composed of three chips: a master chip on a television mother board, a timing controller chip on a driving board of a display panel and a processing chip on a connecting board; and each chip is equipped with a flash memory (FLASH). The FLASH on the television mother board is for storing a parameter required by the master chip for an initialization process, the FLASH on the driving board of the display panel is for storing a parameter required by the timing controller chip for initialization, and the FLASH on the connecting board is mainly for storing a setting parameter required for eliminating display unevenness on the display screen. Actually, the sum of required capacities of FLASH for the above three chips of the television system only is the capacity of one FLASH. If each chip is equipped with one FLASH, which will cause a waste of memory chips.

### SUMMARY

Embodiments of the disclosure provide a display apparatus and its control circuit and control method, so as to increase utilization efficiency of memory chip, reduce the memory chip configuration and reduce the cost consequently.

Specifically, an embodiment of the disclosure provides a control circuit of a display apparatus. The control circuit includes: a communication circuitry; a display driver chip; a master chip, electrically connected to the display driver chip through the communication circuitry; and a memory chip, electrically connected to the master chip through the communication circuitry and configured (i.e., structured and arranged) to store a first configuration parameter of the master chip and a second configuration parameter of the display driver chip of an electronic equipment. The master chip is configured to read the first configuration parameter and the second configuration parameter from the memory chip and send the second configuration parameter to the display driver chip.

In an embodiment, the display driver chip includes a timing controller chip and a processing chip; the timing controller chip and the processing chip are electrically connected to the master chip through the communication circuitry.

In an embodiment, the second configuration parameter includes a timing control configuration parameter and a display unevenness configuration parameter.

In an embodiment, the memory chip is a flash memory or an electrically erasable programmable read-only memory.

In an embodiment, the communication circuitry is a serial peripheral interface (SPI) bus or an inter-integrated circuit (I2C) bus.

An embodiment of the disclosure further provides a display apparatus including a display panel and the control circuit of a display apparatus provided by any one of the above embodiments of the disclosure.

An embodiment of the disclosure still further provides a control method of a control circuit of a display apparatus. The control method includes that: a master chip reads a first configuration parameter of the master chip and a second configuration parameter of a display driver chip from a memory chip through a communication circuitry; the master chip performs a configuration operation according to the first configuration parameter and sends the second configuration parameter to the display driver chip; and the display driver chip performs a configuration operation according to the second configuration parameter.

In an embodiment, the second configuration parameter includes a timing control configuration parameter and a display unevenness configuration parameter.

In an embodiment, the display driver chip includes a timing controller chip and a processing chip; the master chip sends the second configuration parameter to the display driver chip and the display driver chip performs a configuration operation according to the second configuration parameter include that: the master chip sends the timing control configuration parameter to the timing controller chip; the master chip sends the display unevenness configuration parameter to the processing chip; the timing controller chip performs a configuration operation according to the timing control configuration parameter; and the processing chip performs a configuration operation according to the display unevenness configuration parameter.

In an embodiment, the memory chip is a flash memory or an electrically erasable programmable read-only memory; the communication circuitry is a SPI bus or an I2C bus.

The embodiments of the disclosure store the configuration parameters required by the master chip and the display driver chip into the same memory chip, utilize the master chip to read all the configuration parameters stored into the memory chip through the communication circuitry and send the second configuration parameter to the display driver chip, which can solve the problem of waste of memory chip capacity caused by the master chip and the display driver chip respectively being equipped with memory chips, and therefore can improve the utilization efficiency of memory chip, reduce the memory chip configuration and reduce the cost of display apparatus consequently.

### BRIEF DESCRIPTION OF THE DRAWINGS

FIG. 1 is a structural schematic view of a control circuit of a display apparatus provided by an embodiment of the disclosure;

FIG. 2 is a structural schematic view of a control circuit of another display apparatus provided by an embodiment of the disclosure;

FIG. 3 is a structural schematic view of a display apparatus provided by an embodiment of the disclosure;

FIG. 4 is a flowchart of a control method of a control circuit of a display apparatus provided by an embodiment of the disclosure; and

FIG. 5 is a flowchart of a control method of a control circuit of another display apparatus provided by an embodiment of the disclosure.

### DETAILED DESCRIPTION OF EMBODIMENTS

The disclosure will be further described below in detail with reference to accompanying drawings and embodiments. It should be understood that, the specific embodiments described herein are merely for the purpose of illustrating the disclosure and are not intended to limit the disclosure. In addition, it should be noted that, for the convenience of description, the drawings show only a part of rather than all of structures related to the disclosure.

FIG. 1 is a structural schematic view of a control circuit of a display apparatus provided by an embodiment of the disclosure. As illustrated in FIG. 1, the control circuit of a display apparatus includes: a communication circuitry, a display driver chip 120, a master chip 130 and a memory chip 140.

The master chip 130 is electrically connected to the display driver chip 120 through the communication circuitry. The memory chip 140 is electrically connected to the master chip 130 through the communication circuitry and configured (i.e., structured and arranged) to store a first configuration parameter of the master chip 130 and a second configuration parameter of the display driver chip 120 of the display apparatus. The master chip 130 is configured to read the first configuration parameter and the second configuration parameter from the memory chip 140 and send the second configuration parameter to the display driver chip 120.

The display apparatus may be a display device of an electronic equipment such as a television set, a smart phone or a tablet computer, and may concretely be a liquid crystal display device, an OLED (Organic Light-Emitting Diode) display device or a QLED (Quantum dot Light-Emitting Diode) display device. The master chip 130 is a core component of the display apparatus and can control the display apparatus to run and work including coordinately controlling other chip to display a desired image by a display screen. The first configuration parameter may be a parameter required by the master chip 130 for a system initialization process. The second configuration parameter may be an initialization parameter required by the display driver chip 120 for an image display on a display screen. The memory chip 140 may be a read-only memory, a programmable read-only memory, an erasable programmable read-only memory, or a one-time programmable read-only memory, and so on.

Exemplarily, the memory chip 140 is a flash memory or an electrically erasable programmable read-only memory (EEPROM).

Exemplarily, the communication circuitry is a SPI (Serial Peripheral Interface) bus or an I2C (Inter-Integrated Circuit) bus.

If the memory chip 140 is the flash memory, the communication circuitry may be the SPI bus; and if the memory chip 140 is the electrically erasable programmable read-only memory, the communication circuitry is the I2C bus.

In the technical solution of this embodiment, the configuration parameters required by the master chip 130 and the display driver chip 120 are stored into the same memory chip, the master chip 130 reads all the configuration parameters stored in the memory chip 140 through the communication circuitry and send the second configuration parameter to the display driver chip 120, which can solve the problem of waste of memory chip capacity caused by the master chip 130 and the display driver chip 120 being equipped with respective memory chips, and therefore can increase the utilization efficiency of the memory chip, reduce the memory chip configuration and reduce the cost of the display apparatus.

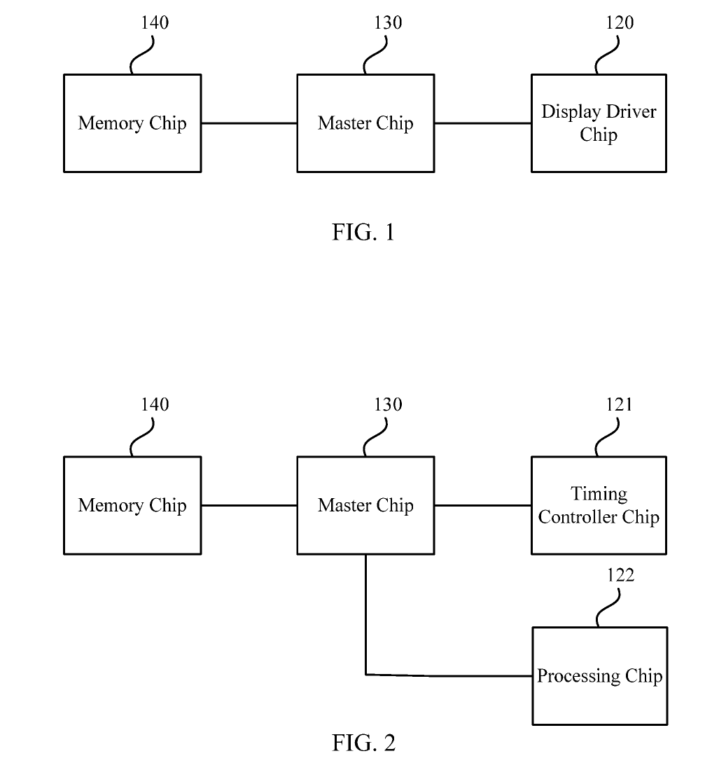

FIG. 2 is a structural schematic view of a control circuit of another display apparatus provided by an embodiment of the disclosure. As illustrated in FIG. 2, this embodiment of the disclosure is an optimization on the basis of the above embodiment, and specifically the display driver chip 120 includes: a timing controller chip 121 and a processing chip 122. The timing controller chip 121 and the processing chip 122 both are electrically connected to the master chip 130 through the communication circuitry. The second configuration parameter includes a timing control configuration parameter and a display unevenness configuration parameter.

The timing controller chip 121 may be used for controlling times, positions and brightnesses of pixels to be turned on and thereby controlling the generation of a desired display image. The processing chip 122 may be used for eliminating uneven display on the display screen, i.e., eliminating the phenomenon of uneven brightness among the pixels on the display screen. The timing control configuration parameter is a configuration parameter required by the timing controller chip 121 for initialization. The display unevenness configuration parameter is a configuration parameter required by the processing chip 122 for eliminating uneven display of the display screen.

The technical solution of this embodiment provides the control circuit of another display apparatus, this embodiment on the basis of the above embodiment, stores the configuration parameters required by the master chip 130, the timing controller chip 121 and the processing chip 122 into the same memory chip, utilizes the master chip 130 to read all the configuration parameters stored in the memory chip 140 through the communication circuitry and send the timing control configuration parameter and the display unevenness configuration parameter to the timing controller chip 121 and the processing chip 122 respectively, which can solve the problem of waste of memory chip capacity caused by the master chip 130, the timing controller chip 121 and the processing chip 122 being equipped with respective memory chips, and therefore can improve the utilization efficiency of the memory chip, reduce the memory chip configuration and reduce the cost of the display apparatus.

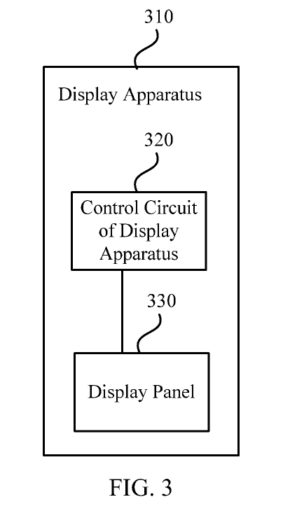

FIG. 3 is a structural schematic view of a display apparatus provided by an embodiment of the disclosure. As illustrated in FIG. 3, the display apparatus 310 includes a display panel 330 and a control circuit 320 of a display apparatus same as that of any one of the above embodiments of the disclosure.

The display apparatus may be a display device of an electronic equipment such as a television set, a smart phone or a tablet computer, and may concretely be a liquid crystal display device, an OLED display device or a QLED display device. If the display apparatus is the liquid crystal display device, the display apparatus further includes a backlight module.

In the technical solution of this embodiment, the display apparatus stores the configuration parameters required by the master chip 130 and the display driver chip 120 into the same memory chip, utilizes the master chip 130 to read all the configuration parameters stored in the memory chip 140 through the communication circuitry and then send the second configuration parameter to the display driver chip 120, which can solve the problem of waste of memory chip capacity caused by the master chip 130 and the display driver chip 120 being equipped with respective memory chips, and therefore can increase the utilization efficiency of the memory chip, reduce the memory chip configuration and reduce the cost of the display apparatus.

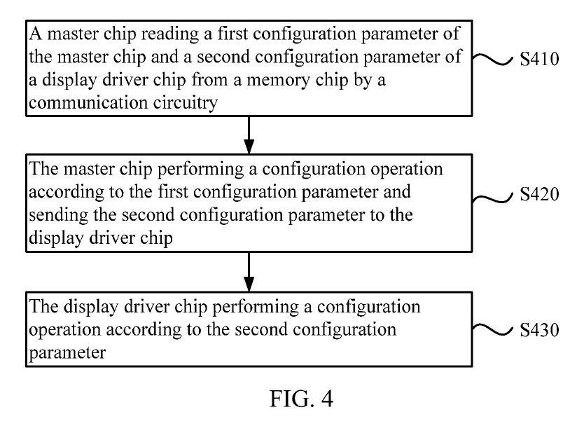

FIG. 4 is a flowchart of a control method of a control circuit of a display apparatus provided by an embodiment of the disclosure. The illustrated embodiment is suitable for increasing the utilization of memory chip of the display apparatus. The method may be carried out by the control circuit of the display apparatus provided by any one embodiment of the disclosure, the control circuit may be integrated into a display apparatus with a display function on a display screen, and the display apparatus may be a display device of an electronic equipment such as a television set, a smart phone or a tablet computer. As illustrated in FIG. 4, the method specifically includes following steps 410 to 430.

Step 410: a master chip reading a first configuration parameter of the master chip and a second configuration parameter of a display driver chip from a memory chip through a communication circuitry.

The first configuration parameter and the second configuration parameter may be stored in the memory chip before leaving the factory. Alternatively, the first configuration parameter and the second configuration parameter may be written into the memory chip before the master chip reading the first configuration parameter of the master chip and the second configuration parameter of the display driver chip from the memory chip through the communication circuitry.

Exemplarily, the second configuration parameter includes a timing control configuration parameter and a display unevenness configuration parameter. The timing control configuration parameter is a configuration parameter required by the display driver chip for initialization. The display unevenness configuration parameter is a configuration parameter required for eliminating uneven display on a display screen.

Exemplarily, the memory chip is a flash memory or an electrically erasable programmable read-only memory.

Exemplarily, the communication circuitry is a serial peripheral interface bus or an inter-integrated circuit bus.

Step 420: the master chip performing a configuration operation according to the first configuration parameter and sending the second configuration parameter to the display driver chip.

The configuration operation may be that the master chip assigns the first configuration parameter to a corresponding system variable to achieve a condition required for system initialization.

Step 430: the display driver chip performing a configuration operation according to the second configuration parameter.

In particular, the display driver chip performs the configuration operation according to the second configuration parameter to display a desired image.

In the technical solution of this embodiment, by storing the configuration parameters required by the master chip 130 and the display driver chip 120 into the same memory chip, using the master chip 130 to read all the configuration parameters stored in the memory chip 140 through the communication circuitry and send the second configuration parameter to the display driver chip 120, which can solve the problem of waste of memory chip capacity caused by the master chip 130 and the display driver chip 120 being equipped with respective memory chips, and therefore can increase the utilization efficiency of the memory chip, reduce the memory chip configuration and reduce the cost of the display apparatus.

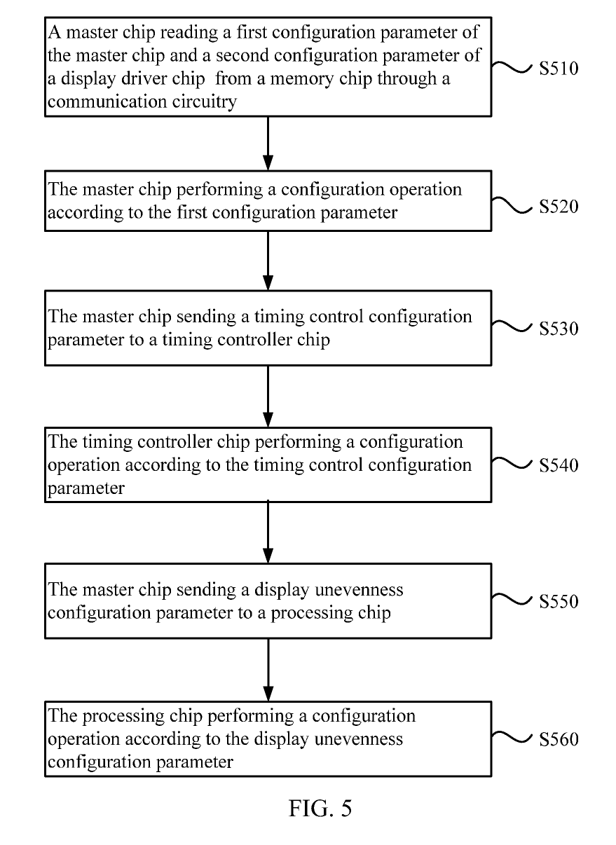

FIG. 5 is a flowchart of a control method of a control circuit of another display apparatus provided by an embodiment of the disclosure. The embodiment is an optimization on the basis of the above embodiment, and specifically the display driver chip includes: a timing controller chip and a processing chip. The master chip sending the second configuration parameter to the display driver chip and the display driver chip performing a configuration operation according to the second configuration parameter specifically include that: the master chip sending the timing control configuration parameter to the timing controller chip, the master chip sending the display unevenness configuration parameter to the display unevenness processing chip, the timing controller chip performing a configuration operation according to the timing control configuration parameter, and the processing chip performing a configuration operation according to the display unevenness configuration parameter.

Correspondingly, the method of this embodiment includes following steps 510 to 560.

Step 510: a master chip reading a first configuration parameter of the master chip and a second configuration parameter of a display driver chip from a memory chip through a communication circuitry.

In particular, the first configuration parameter, the timing control configuration parameter and the display unevenness configuration parameter may be stored into a first preset storage space, a second preset storage space and a third preset storage space of the memory chip. The master chip may determine the chip corresponding to the configuration parameter which is read from the memory chip according to the location of the storage space to be read.

Step 520: the master chip performing a configuration operation according to the first configuration parameter.

Step 530: the master chip sending a timing control configuration parameter to a timing controller chip.

Step 540: the timing controller chip performing a configuration operation according to the timing control configuration parameter.

In particular, the timing controller chip performs the configuration operation according to the timing control configuration parameter so as to control times, positions and brightnesses of pixels to be turned on and thereby control the generation of a desired display image.

Step 550: the master chip sending the display unevenness configuration parameter to a processing chip.

Step 560: the processing chip performing a configuration operation according to the display unevenness configuration parameter.

In particular, the processing chip performs the configuration operation according to the display unevenness configuration parameter, so as to eliminate the phenomenon of uneven brightness among the pixels of the display screen.

The technical solution of this embodiment provides a control method of a control circuit of another display apparatus, this embodiment on the basis of the above embodiment, stores the configuration parameters required by the master chip 130, the timing controller chip 121 and the processing chip 122 into the same memory chip, utilizes the master chip 130 to read all the configuration parameters stored in the memory chip 140 through the communication circuitry and send the timing control configuration parameter and the display unevenness configuration parameter to the timing controller chip 121 and the processing chip 122 respectively, which can solve the problem of waste of memory chip capacity caused by the master chip 130, the timing controller chip 121 and the processing chip 122 being equipped with respective memory chips, and therefore can improve the utilization efficiency of the memory chip, reduce the memory chip configuration and reduce the cost of the display apparatus.

It is noted that, the foregoing only are preferred embodiments and used technical principles of the disclosure. It should be understood to those skilled in the art that the disclosure is not limited to the specific embodiments described herein, it will be apparent to those skilled in the art that various changes, modifications arid substitutions can be made without departing from the scope of the disclosure. Therefore, although the disclosure is described in detail through the above embodiments, the disclosure is not limited to the above embodiments, other alternative embodiments may be included without departing from the spirit of the disclosure, and the scope of the disclosure is determined by the scope of the appended claims.

What is claimed is:

1. A control circuit of a display apparatus, comprising
a communication circuitry;
a display driver chip;
a master chip, electrically connected to the display driver chip through the communication circuitry; and
a memory chip, electrically connected to the master chip through the communication circuitry and configured to store a first configuration parameter of the master chip and a second configuration parameter of the display driver chip of an electronic equipment;
wherein the master chip is configured to read the first configuration parameter and the second configuration parameter from the memory chip and send the second configuration parameter to the display driver chip.

2. The control circuit of a display apparatus according to claim 1, wherein the display driver chip comprises a timing controller chip and a processing chip; the timing controller chip and the processing chip are electrically connected to the master chip through the communication circuitry.

3. The control circuit of a display apparatus according to claim 1, wherein the second configuration parameter comprises a timing control configuration parameter and a display unevenness configuration parameter.

4. The control circuit of a display apparatus according to claim 2, wherein the second configuration parameter comprises a timing control configuration parameter and a display unevenness configuration parameter.

5. The control circuit of a display apparatus according to claim 1, wherein the memory chip is a flash memory and an electrically erasable programmable read-only memory.

6. The control circuit of a display apparatus according to claim 1, wherein the communication circuitry is a serial peripheral interface bus or an inter-integrated circuit bus.

7. A display apparatus, comprising a display panel and the control circuit of a display apparatus according to claim 1.

8. The display apparatus according to claim 7, wherein the display driver chip comprises a timing controller chip and a processing chip; the timing controller chip and the processing chip are electrically connected to the master chip through the communication circuitry.

9. The display apparatus according to claim 7, wherein the second configuration parameter comprises a timing control configuration parameter and a display unevenness configuration parameter.

10. The display apparatus according to claim 8, wherein the second configuration parameter comprises a timing control configuration parameter and a display unevenness configuration parameter.

11. The display apparatus according to claim 7, wherein the memory chip is a flash memory or an electrically erasable programmable read-only memory.

12. The display apparatus according to claim 7, wherein the communication circuitry is a serial peripheral interface bus or an inter-integrated circuit bus.

13. A control method of a control circuit of a display apparatus, comprising:
a master chip reading a first configuration parameter of the master chip and a second configuration parameter of a display driver chip from a memory chip through a communication circuitry;
wherein the master chip performs a configuration operation according to the first configuration parameter and sends the second configuration parameter to the display driver chip; and
wherein the display driver chip performs a configuration operation according to the second configuration parameter.

14. The control method according to claim 13, wherein the second configuration parameter comprises a timing control configuration parameter and a display unevenness configuration parameter.

15. The control method according to claim 14, wherein the display driver chip comprises a timing controller chip and a processing chip;
wherein the master chip sends the second configuration parameter to the display driver chip and the display driver chip performs a configuration operation according to the second configuration parameter comprise:
the master chip sends the timing control configuration parameter to the timing controller chip;
the master chip sends the display unevenness configuration parameter to the processing chip;
the timing controller chip performs a configuration operation according to the timing control configuration parameter;
the processing chip performs a configuration operation according to the display unevenness configuration parameter.

16. The control method according to claim 13, wherein the memory chip is a flash memory or an electrically erasable programmable read-only memory; the communication circuitry is a serial peripheral interface bus or an inter-integrated circuit bus.

17. The control method according to claim 14, wherein the memory chip is a flash memory or an electrically erasable programmable read-only memory.

18. The control method according to claim 15, wherein the memory chip is a flash memory or an electrically erasable programmable read-only memory.

19. The control method according to claim 14, wherein the communication circuitry is a serial peripheral interface bus or an inter-integrated circuit bus.

20. A control method of a control circuit of a display apparatus, wherein the control method of the display apparatus comprises a communication circuitry, a display driver chip, a master chip and a memory chip; the display driver chip comprises a timing controller chip and a processing chip;
the control method of the control circuit of the display apparatus comprises:
the master chip reading a first configuration parameter, a timing control configuration parameter and a display unevenness configuration parameter from the memory chip through the communication circuitry, wherein the first configuration parameter, the timing control configuration parameter and the display unevenness configuration parameter respectively are stored in a first preset storage space, a second preset storage space and a third preset storage space of the memory chip, the master chip determines the chip corresponding to the configuration parameter read from the memory chip according to the location of the storage space to be read;
wherein the master chip performs a configuration operation according to the first configuration parameter;
wherein the master chip sends the timing control configuration parameter to the timing controller chip;
wherein the timing controller chip performs a configuration operation according to the timing control configuration parameter to control times, positions and brightnesses of pixels to be turned on and thereby control a generation of a desired display image;
wherein the master chip sends the display unevenness configuration parameter to the processing chip; and
wherein the processing chip performs a configuration operation according to the display unevenness configuration parameter.
